(19) United States
(12) Patent Application Publication
(10) Pub. No.: US 2005/0176564 A1
(43) Pub. Date: Aug. 11, 2005

(54) Solid metallic rolling pin

(76) Inventor: Michael J. Christy, Carrollton, TX (US)

Correspondence Address: Michael L. Diaz;Michael L. Diaz, P.C., Suite 200, 555 Republic Drive, Plano, TX, 75074, US

(21) Appl. No.: 10/773,133

(22) Filed: Feb. 6, 2004

(51) Int. Cl. A21C 3/02; B05C 1/08

(52) U.S. Cl. 492/14; 492/19

(57) ABSTRACT

An improved rolling pin constructed of a solid metallic substance is disclosed. The rolling pin is preferably constructed of an aluminum substance. The rolling pin includes a main body having a solid shaft that tapers to two opposing ends. Each end includes a ball shaped handle. The rolling pin may then be powder coated to provide a unique metallic coating. The rolling pin is contoured and weighted to provide outstanding controlling characteristics.

### BACKGROUND OF THE INVENTION

1. Technical Field of the Invention

This invention relates to cooking accessories, and more particularly, to an improved rolling pin for use in cooking.

2. Description of Related Art

Rolling pins are commonly used in cooking. A conventional rolling pin is constructed of wood and includes a cylindrically-shaped roller which rotates about a shaft. The rolling pin is commonly used to flatten dough or other food mixtures/articles. An individual grasps a rolling pin by two handles, one located on each side of the shaft. The individual then rolls the roller upon the dough or other food article, thereby rotating the rolling pin about its shaft and simultaneously flattening the food article. However, existing rolling pins suffer from several disadvantages. First, the roller pin is constructed of wood. The roller area works appreciably better if its surface is cool. It would be advantageous if the roller could be stored in the refrigerator to have its surface cooled. However, wood does not retain a cold temperature for a long period of time. Therefore, cooks do not store the rolling pin in refrigerators to cool its surface. Existing rolling pins are also not weighted properly to effectively roll the food article. Specifically, existing rolling pins are light, due to the fact that wood is not very dense. A heavier, denser material is desirable to enable the food article to be effectively rolled. In addition, existing rolling pins do not allow the use of powder coated. Powder coating would allow the rolling pin to be coated with a metallic or non-metallic color which definitively enhances the appearance of the rolling pin. Powder coating is an effective way to color the outer surface of a metallic surface without contaminating the food article.

Existing devices reveal no disclosure or suggestion of a rolling pin providing the ability to be cooled, allow the application of powder coating to enhance the aesthetics of the rolling pin, or weighted and configured in a fashion to optimize the rolling process. It is an object of the present invention to provide such an apparatus.

### SUMMARY OF THE INVENTION

In one aspect, the present invention is an improved rolling pin for use upon a food article. The rolling pin includes a cylindrically-shaped main body having a first end and a second end. In addition, the rolling pin includes a first ball-shaped handle affixed to the first end and a second ball-shaped handle affixed to the second end. The main body and handles are composed of a solid metallic substance.

In another aspect, the present invention is an improved rolling pin for use upon a food article. The rolling pin includes a cylindrically-shaped main body having a first end and a second end. The main body tapers to the first end and the second end. The rolling pin also includes a first ball-shaped handle affixed to the first end and a second ball-shaped handle affixed to the second end. A powder coating is applied to the main body, the first end, and the second end. The main body, first handle and second handle are composed of a solid aluminum based substance.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a side elevational view of a rolling pin in the preferred embodiment of the present invention;

FIG. 2 is a side end view of the rolling pin of FIG. 1;

FIG. 3 is a front perspective view of the rolling pin being operated by a user in the preferred embodiment of the present invention;

FIG. 4 is a side elevational view of a rolling pin in a first alternate embodiment of the present invention; and

FIG. 5 is a side elevational view of a rolling pin in a second alternate embodiment of the present invention.

### DETAILED DESCRIPTION OF EMBODIMENTS

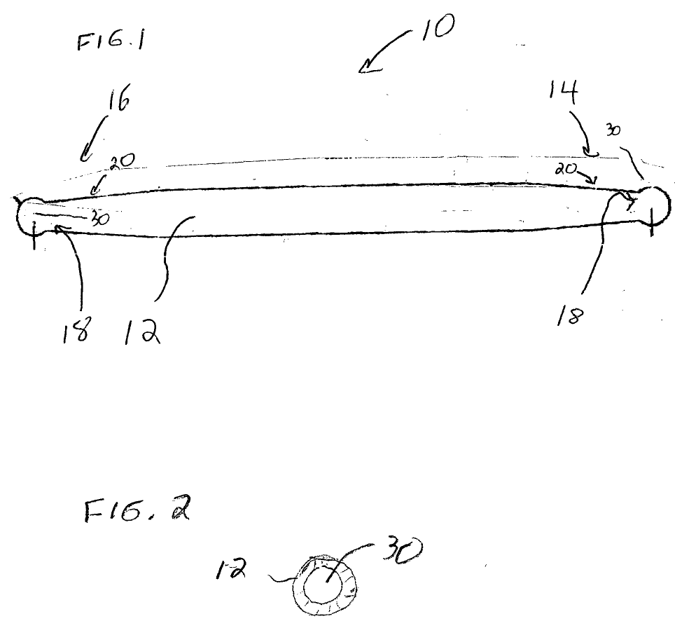

An improved rolling pin is disclosed. FIG. 1 is a side elevational view of a rolling pin 10 in the preferred embodiment of the present invention. The rolling pin includes a cylindrically-shaped main body 12 with opposing ends 14 and 16. Upon each end is a ball-shaped handle 18. Between each handle and the main body is a tapered portion 20.

The entire rolling pin 10 is constructed of a metallic substance. In the preferred embodiment, the material is aluminum. However, the rolling pin may be constructed of any rigid material, such as stainless steel or a composite material. Preferably, the rolling pin is solid, thereby providing a heavier rolling pin than conventional rolling pins.

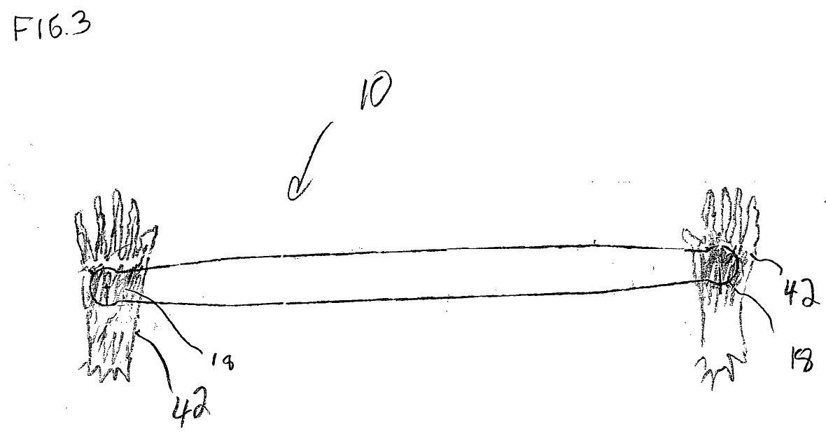

FIG. 2 is a side end view of the rolling pin 10 of FIG. 1. The handles are sized to comfortably fit within the palms of the user. The handles include a ball 30 having a diameter of approximately one inch. The main body has a slightly larger diameter of approximately 1 and 1/4 inches. In addition, the length of the entire rolling pin is approximately 18 inches. The total weight of the rolling pin is between 2 and 3 pounds. It should be understood that the dimensions and weight of the rolling pin may be different than the preferred embodiment, while still remaining in the scope of the present invention.

In the preferred embodiment, the rolling pin is of a unitary constructed and is manufactured from a single shaft of aluminum or other metallic substance. The shaft is then lathed to the shape of the improved rolling pin 10.

FIG. 3 is a front perspective view of the rolling pin 10 being rolled by the hands 42 of a user in the preferred embodiment of the present invention. The user preferably places the palms of his hands 42 on top of the ball-shaped handles 18. The handles are rolled upon the palms, thereby moving the rolling pin. It should be noted, that unlike existing rolling pins, the handles are fixed to the main body, thus providing a unitary structure. The rolling of the rolling pin is accomplished by rolling the handles upon the palms of hands of the user. In addition, the ball-shaped handles prevent the hands of the user from falling off the rolling pin handles.

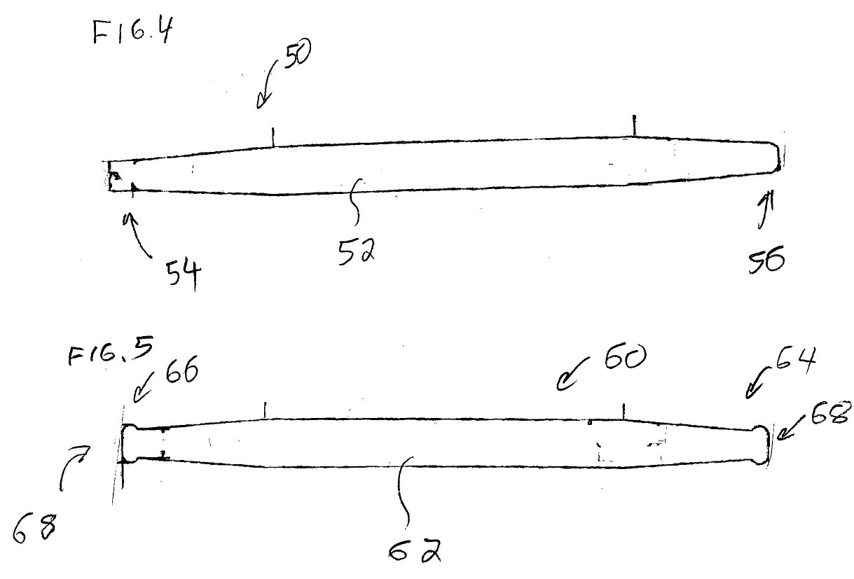

FIG. 4 is a side elevational view of a rolling pin 50 in a first alternate embodiment of the present invention. The rolling pin 50 may include a main body 52 with ends 54 and 56, without the addition of any handles. FIG. 5 is a side elevational view of a rolling pin 60 in a second alternate embodiment of the present invention. The rolling pin 60 may include a main body 62 and ends 64 and 66. The ends may include capped handles 68. The capped handles are similar to ends found on the end of a baseball bat. Both the rolling pins 50 and 60 are made of a solid metallic substance.

As discussed above, the rolling pin is preferably constructed of an aluminum material. The main body is preferably a solid material without any hollow portions, thus adding weight to the rolling pin. Since the rolling pin is constructed of a metallic substance, a powder coating may be applied to the rolling pin. Preferably, the powder coating process is a Federal Drug Administration (FDA) approved process. Thus the powder coating is acceptable for application to a food article. In addition, the powder coating allows the application of distinct metallic and non-metallic colors which enhances the aesthetics of the rolling pin. In an alternate embodiment, the material coating the rolling pin may be subjected to a coloring process, such as an anodizing process.

With reference to FIGS. 1-3, the operation of the rolling pin 10 will now be discussed. The rolling pin, as desired by the user, may be stored in a refrigerated area, such as a refrigerator. Cooling of the surface of the rolling pin provides a cooled surface area which may be helpful in the rolling process upon the food article. For example, there are many pastry does which must be rolled while the dough is still cold. Once the dough is removed from a refrigerated area, application of a conventional rolling pin caused the dough to warm. Once the dough is warmed up, the dough is difficult to roll without chilling the dough again. However, by utilizing a chilled rolling pin, the dough remains cool for a longer period of time. When desired, a food article is laid on a flat surface. The rolling pin is positioned above the food article. The rolling pin is grasped by positioning the user's hands upon the ends 14 and 16. The palms of the user's hands are preferably positioned upon the ball portion of the handles. The remaining portion of each hand rests over the ends of rolling pin and the taped portions 20 of the rolling pin. The rolling pin is then rolled by rolling the balls upon the hands of the user.

The present invention provides many advantages over existing rolling pins. The rolling pin 10 enables the application of color to the surface of the rolling pin, which was not feasible with rolling pins constructed of wood. The powder coating provides a very distinctive and unusual appearance to the rolling pin 10. In addition, the rolling pin 10 is constructed of a metallic substance suitable for retaining a cool temperature. By cooling the surface of the rolling pin 10, the food article is easier, in many cases (e.g., butter-based dough), to roll. Additionally, the rolling pin 10 is sized, contoured and weighed for optimal handling of the rolling pin and use in rolling a food article.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

1. An improved rolling pin for use upon a food article, the rolling pin comprising:
a cylindrically-shaped main body having a first end and a second end;
a first ball-shaped handle affixed to the first end; and
a second ball-shaped handle affixed to the second end;
wherein the main body, first handle and second handle are composed of a solid metallic substance.

2. The improved rolling pin of claim 1 wherein the solid metallic substance is aluminum.

3. The improved rolling pin of claim 1 wherein the main body includes a first taper portion adjacent the first end and a second taped portion adjacent the second end.

4. The improved rolling pin of claim 1 wherein the main body is powder coated.

5. The improved rolling pin of claim 4 wherein the powder coating is approved by the Federal Drug Administration.

6. The improved rolling pin of claim 4 wherein the powder coating provides a specific color to the rolling pin.

7. The improved rolling pin of claim 1 wherein the main body, the first handle and the second handle are powder coated.

8. The improved rolling pin of claim 1 wherein the main body is constructed from a solid shaft of the metallic substance.

9. The improved rolling pin of claim 1 wherein the metallic substance is stainless steel.

10. The improved rolling pin of claim 1 wherein the length of the rolling pin measured from the first handle to the second handle is approximately 18 inches.

11. The improved rolling pin of claim 1 wherein the main body is approximately 1 and 1/4 inches in diameter.

12. The improved rolling pin of claim 1 wherein the rolling pin has a total weight of between 2 and 3 pounds.

13. An improved rolling pin for use upon a food article, the rolling pin comprising:
a cylindrically-shaped main body having a first end and a second end, the main body tapering to the first end and the second end;
a first ball-shaped handle affixed to the first end;
a second ball-shaped handle affixed to the second end;
a powder coating applied to the main body, the first end, and the second end;
wherein the main body, first handle and second handle are composed of a solid aluminum based substance.

14. The improved rolling pin of claim 13 wherein the rolling pin is constructed of a single unitary piece of the sold aluminum based substance.
